(19) United States
(12) Patent Application Publication
(10) Pub. No.: US 2026/0167286 A1
(43) Pub. Date: Jun. 18, 2026

(54) MOBILE ROBOT

(71) Applicant: Rainier Labs Corporation, Campbell, CA (US)

(72) Inventors: Punarjay Chakravarty, Campbell, CA (US); Gopisainath Mamindlapalli, San Jose, CA (US); Anuroop Iyengar, Dallas, TX (US)

(73) Assignee: Rainier Labs Corporation, Campbell, CA (US)

(21) Appl. No.: 18/978,258

(22) Filed: Dec. 12, 2024

(51) Int. Cl. B62D 57/032; B25J 9/10

(52) U.S. Cl. CPC B62D 57/032; B25J 9/102

(57) ABSTRACT

A robotic apparatus includes a main body, an attachment fixture fixed relative to the main body, a hip actuator coupled to the main body, a wheel hub coupled to the hip actuator, a leg hub coupled to the wheel hub, and a leg segment fixed relative to the leg hub. The wheel hub is rotatably drivable by the hip actuator. The leg segment is elongated radially outward from the leg hub. The leg segment is detachably couplable to the attachment fixture. The leg hub is rotatably drivable by the hip actuator together with the wheel hub when the leg segment is decoupled from the attachment fixture. The leg hub is rotationally fixed relative to the main body and the wheel hub is rotatably drivable by the hip actuator independently of the leg hub when the leg segment is coupled to the attachment fixture.

### BACKGROUND

Mobile robots can use various modes of locomotion to move around their environments. Some robots roll using wheels or tracks. Some robots walk using legs. Other types of locomotion include hopping, swimming, flying, and gliding.

### BRIEF DESCRIPTION OF THE DRAWINGS

FIG. 1 is a perspective view of an example mobile robot.

FIG. 2 is a perspective view of a portion of the mobile robot.

FIG. 3 is a perspective exploded view of components at a hip joint of the mobile robot.

FIG. 4 is a side exploded view of the components at the hip joint.

FIG. 5 is a perspective view of the components at the hip joint.

### DETAILED DESCRIPTION

With reference to the Figures, wherein like numerals indicate like parts throughout the several views, a robotic apparatus 102 of a robot 100 includes a main body 104, an attachment fixture 106 fixed relative to the main body 104, a hip actuator 108 coupled to the main body 104, a wheel hub 110 coupled to the hip actuator 108, a leg hub 112 coupled to the wheel hub 110, and an upper leg segment 114. The term “robotic apparatus” is used to refer to all or a part of the robot 100. The hip actuator 108 defines a hip axis of rotation A1. The wheel hub 110 is centered on the hip axis A1 and rotatably drivable by the hip actuator 108 about the hip axis A1. The leg hub 112 is centered on the hip axis A1. The upper leg segment 114 is elongated radially outward from the leg hub 112 relative to the hip axis A1. The upper leg segment 114 is fixed relative to the leg hub 112. The upper leg segment 114 is detachably couplable to the attachment fixture 106. The leg hub 112 is rotatably drivable by the hip actuator 108 together with the wheel hub 110 when the upper leg segment 114 is decoupled from the attachment fixture 106. The leg hub 112 is rotationally fixed relative to the main body 104 and the wheel hub 110 is rotatably drivable by the hip actuator 108 independently of the leg hub 112 when the upper leg segment 114 is coupled to the attachment fixture 106.

The robotic apparatus 102 provides an efficient design for a dual-mode robot. The robot 100 is switchable between a leg mode in which the form of locomotion is walking and a wheel mode in which the form of locomotion is driving. In the leg mode, the robot 100 walks around the environment using the upper leg segment 114. In the wheel mode, the robot 100 rolls around the environment on the wheel hub 110. For example, the robot 100 may use the wheel mode to move around more quickly on flat surfaces, and the robot 100 may use the leg mode to handle more difficult terrain. Beneficially, the same motor, namely the hip actuator 108, is used for both walking and driving. The hip actuator 108 moves the upper leg segment 114 to support walking, and the hip actuator 108 drives the wheel hub 110 when the upper leg segment 114 is rotationally fixed. No additional motor is needed for driving versus walking.

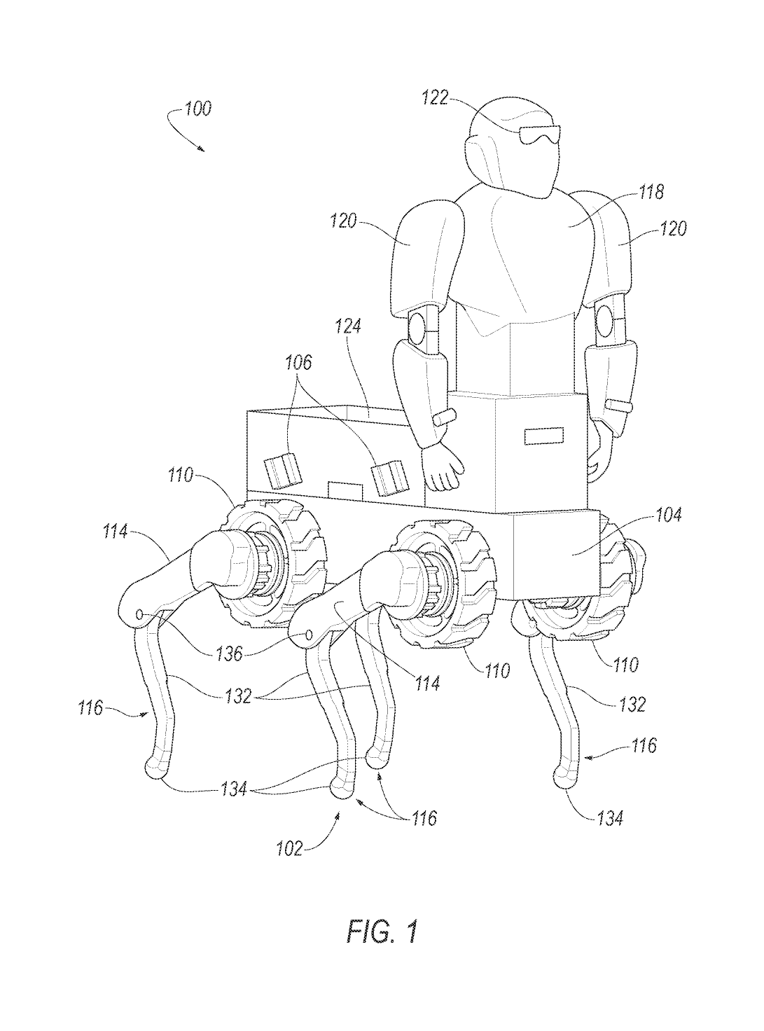

With reference to FIG. 1, the main body 104 may be a central fixture of the robot 100. The main body 104 may serve as an attachment point for appendages and other features of the robot 100. The main body 104 may include a rigid frame (not shown) and a housing around the frame. The frame may provide support for the different components of the robot 100 extending from the main body 104. The main body 104 may house components of the robot 100 internally inside the housing, such as batteries, computers, wiring, etc. The shape of the main body 104 may define a coordinate system for the robot 100, including a longitudinal axis x (i.e., forward and rearward), a lateral axis y (i.e., left and right), and a vertical axis z (i.e., up and down). Terms such as “front,” “forward,” “longitudinal,” “back,” “rearward,” “left,” “right,” “lateral,” “upward,” “downward,” “vertical,” etc., are understood relative to the coordinate system.

The robot 100 includes a plurality of leg assemblies 116. The leg assemblies 116 extend outward from the main body 104. Depending on the positioning of the leg assemblies 116 (e.g., whether the robot 100 is in the leg mode or the wheel mode), the leg assemblies 116 may support the main body 104 and the rest of the robot 100, and the leg assemblies 116 may provide locomotion for the robot 100. The components of the leg assemblies 116 are described in detail below. The components and arrangement of the components of a single leg assembly 116 (as will be described below) may be the same for each of the leg assemblies 116.

The robot 100 may include an even number of leg assemblies 116, e.g., two or four. In particular, the robot 100 may include four leg assemblies 116, which can provide stability for the robot 100 without the need for constantly adjusting the balance. The leg assemblies 116 may be symmetrically arranged across a vertical and longitudinal plane (i.e., across a centerline of the main body 104). The robot 100 may include two front leg assemblies 116 and two rear leg assemblies 116. The main body 104 may have a greater length along the longitudinal axis x than height along the vertical axis z or width along the lateral axis y, in order to space apart the front and rear leg assemblies 116.

The robot 100 may include a torso 118 extending upward from the main body 104 (e.g., from a front end of the main body 104). The torso 118 may provide greater height for mounting actuatable arms 120 and/or environmental sensors (not numbered). The torso 118 may also help give a partially human-like appearance to the robot 100, when combined with actuatable arms 120 and a head 122.

The robot 100 may include at least one actuatable arm 120 coupled to the main body 104. For example, the at least one actuatable arm 120 may be coupled to the main body 104 indirectly via the torso 118. For example, the robot 100 may include two actuatable arms 120 extending from the torso 118, to give a partially human-like appearance. The actuatable arms 120 may have multiple degrees of freedom and may have hands or grippers at the ends of the actuatable arms 120, as is known. The actuatable arms 120 may be actuatable for grabbing and lifting objects.

The robot 100 may include a storage compartment 124 mounted to the torso 118. The storage compartment 124 may provide space for the robot 100 to carry objects. For example, the storage compartment 124 may be an open basket located on top of the main body 104, as shown in FIG. 1. Alternatively, the storage compartment 124 may be enclosable.

The robot 100 includes at least one attachment fixture 106. For example, the robot 100 may include one attachment fixture 106 for each leg assembly 116, e.g., four. As described below, the attachment fixtures 106 are shaped to detachably couple respective leg segments 114, 132 of the leg assemblies 116. The attachment fixtures 106 are fixed relative to the main body 104. For example, the attachment fixtures 106 may be fixedly attached to the main body 104. The attachment fixtures 106 may be located on lateral sides of the main body 104 so as to be within reach of the leg assemblies 116. The attachment fixtures 106 may be positioned above the respective attachment points of the leg assemblies 116 (e.g., above ab/ad actuators 126 and the hip actuators 108) so that the leg segments 114, 132 extend upward when coupled to the attachment fixtures 106.

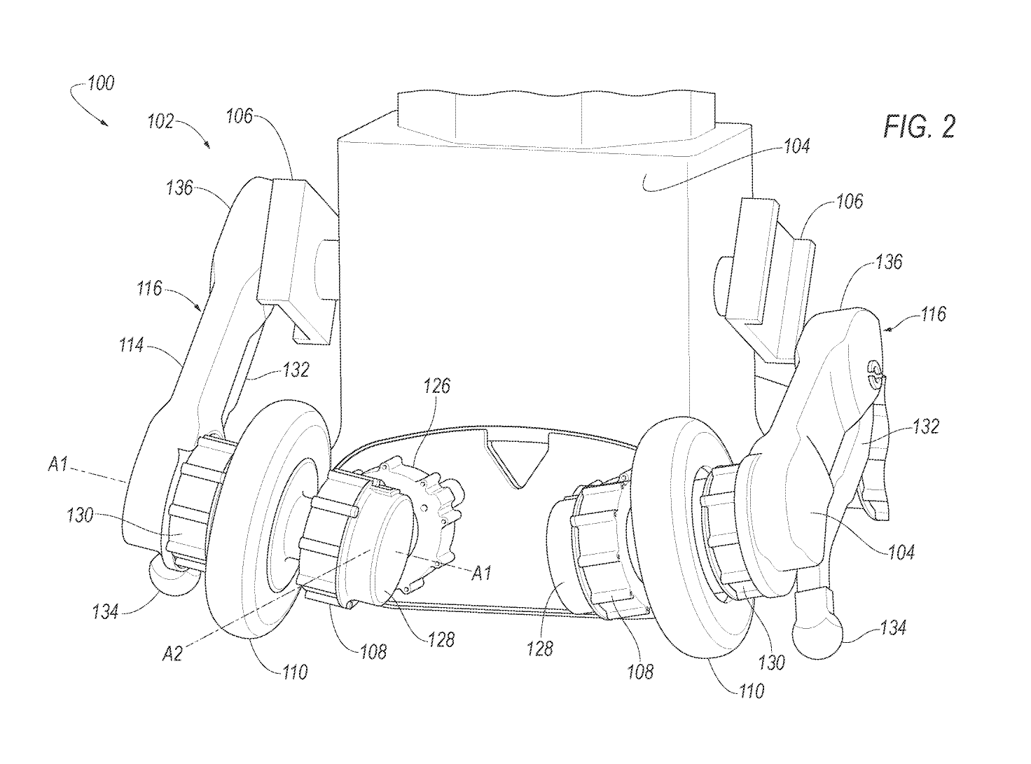

With reference to FIGS. 1–2, each leg assembly 116 may include the ab/ad actuator 126, an ab/ad linkage 128, the hip actuator 108, the wheel hub 110, the leg hub 112, the upper leg segment 114, a knee actuator 130, a lower leg segment 132, and a foot 134, which may be connected together in the foregoing order.

With reference to FIG. 2, the actuators 108, 126, 130 may be rotary actuators, i.e., actuatable to output rotational motion. The actuators 108, 126, 130 may each have a mounted side and an output side that is actuatable to rotate relative to the mounted side. For example, the actuators 108, 126, 130 may be electric motors, e.g., stepper motors that can be actuated to rotate to specific angular positions. The actuators 108, 126, 130 may each include a stator as part of the mounted side and a rotor as part of the output side.

The ab/ad actuator 126 is mounted to the main body 104. For example, the mounted side of the ab/ad actuator 126 may be coupled to the main body 104 and fixed relative to the main body 104. The ab/ad actuator 126 defines an ab/ad axis of rotation A2, about which the output side of the ab/ad actuator 126 rotates relative to the mounted side of the ab/ad actuator 126. The ab/ad axis A2 may be oriented generally longitudinally relative to the main body 104 (e.g., less than 45° from the longitudinal axis defined by the main body 104).

The ab/ad actuator 126 couples the hip actuator 108 to the main body 104; i.e., the hip actuator 108 is coupled to the main body 104 via the ab/ad actuator 126. For example, the ab/ad linkage 128 directly connects the hip actuator 108 and the ab/ad actuator 126. The ab/ad actuator 126 is positioned to rotate the hip actuator 108 (as well as the components down the leg assembly 116 from the hip actuator 108) about the ab/ad axis A2. For example, the ab/ad linkage 128 extends from the output side of the ab/ad actuator 126 to the mounted side of the hip actuator 108. The ab/ad linkage 128 may be a rigid body (i.e., lacking internal joints), and the ab/ad linkage 128 may be fixedly attached to the output side of the ab/ad actuator 126 and the mounted side of the hip actuator 108. The ab/ad linkage 128 may position the hip actuator 108 at approximately the same height as the ab/ad actuator 126, e.g., at an overlapping height with the ab/ad actuator 126.

The hip actuator 108 defines the hip axis A1, about which the output side of the hip actuator 108 rotates relative to the mounted side of the hip actuator 108. The hip axis A1 may be oriented generally laterally relative to the main body 104. The hip axis A1 is nonparallel to the ab/ad axis A2, in other words, either skew or transverse to the ab/ad axis A2. The hip axis A1 and the ab/ad axis A2 may have a fixed relationship defined by the shape of the ab/ad linkage 128. Actuating the ab/ad actuator 126 moves the mounted side of the hip actuator 108 and thereby moves the hip axis A1. Actuating the ab/ad actuator 126 may tilt the hip axis A1 upward and downward relative to the main body 104.

The wheel hub 110 is coupled to the hip actuator 108. For example, the wheel hub 110 is rigidly attached to the output side of the hip actuator 108. The wheel hub 110 is thus rotatably drivable by the hip actuator 108 about the hip axis A1. The wheel hub 110 may have a rotationally symmetrical shape (described in more detail below) that is centered on the hip axis A1. The wheel hub 110 may be a rigid body (i.e., lacking internal joints). As described below, the wheel hub 110 may include multiple parts fixedly attached together.

The leg hub 112 is coupled to the wheel hub 110. The leg hub 112 may may have a rotationally symmetrical shape (described in more detail below) that is centered on the hip axis A1. The leg hub 112 may be a rigid body (i.e., lacking internal joints). The leg hub 112 may either rotate about the hip axis A1 with the wheel hub 110 or may be held rotationally stationary while the wheel hub 110 rotates, as described in more detail below.

The upper leg segment 114 is elongated from the leg hub 112 to a knee joint 136. The upper leg segment 114 is elongated radially outward from the leg hub 112 relative to the hip axis A1. For example, the upper leg segment 114 may have a significantly longer length than the width or depth of the upper leg segment 114, and the length may extend radially from the hip axis A1. The upper leg segment 114 may be a rigid body (i.e., lacking internal joints). The upper leg segment 114 is fixed relative to the leg hub 112. For example, the upper leg may be a single piece with the leg hub 112, or the upper leg segment 114 may be rigidly attached to the leg hub 112, as shown in the Figures.

The lower leg segment 132 is elongated from the knee joint 136 to the foot 134. The lower leg segment 132 is rotatably coupled to the upper leg segment 114 at the knee joint 136. The lower leg segment 132 may be rotatable about an axis defined by the knee joint 136 relative to the upper leg segment 114. The lower leg segment 132 may have one rotational degree of freedom with respect to the upper leg segment 114 via the knee joint 136. The lower leg segment 132 may be elongated radially outward from the knee joint 136 relative to the axis defined by the knee joint 136. For example, the lower leg segment 132 have a significantly longer length than the width or depth of the lower leg segment 132, and the length may extend radially from the knee joint 136. The lower leg segment 132 may be a rigid body (i.e., lacking internal joints).

The knee actuator 130 is positioned to rotatably drive the lower leg segment 132 relative to the upper leg segment 114, e.g., to cause the lower leg segment 132 to rotate with respect to the upper leg segment 114. For example, the knee actuator 130 may be positioned concentrically in the leg hub 112 and centered on the hip axis A1. The knee actuator 130 may be drivably connected to the lower leg segment 132 via a belt or the like running through the upper leg segment 114 (not shown). This location for the knee actuator 130 may reduce the moment of inertia of the leg assembly 116 compared to locating the knee actuator 130 at the knee joint 136.

The foot 134 is positioned at an opposite end of the lower leg segment 132 than the knee joint 136. The foot 134 may be fixed relative to the lower leg segment 132. The foot 134 may be chosen to provide high friction with respect to a surface on which the robot 100 is walking, e.g., a rubber cap.

The upper leg segment 114 is detachably couplable to the respective attachment fixture 106. For the purposes of this disclosure, “detachably couplable” means that two objects can be coupled to each other and that the two objects can be detached from each other in a manner that does not damage either of the two objects and allows the two objects to be re-coupled. When the upper leg segment 114 is coupled to the attachment fixture 106, the upper leg segment 114 is rotationally fixed relative to the main body 104. For example, as shown in the Figures, the attachment fixture 106 may have a slot extending radially from the hip axis A1, with a width sized for receiving the upper leg segment 114. When the upper leg segment 114 is positioned in the attachment fixture 106, the sides of the slot of the attachment fixture 106 block the upper leg segment 114 from rotating either direction around the hip axis A1. For other examples, the attachment fixture 106 may have a pin corresponding to a hole through the upper leg segment 114 (or vice versa), the attachment fixture 106 may include a magnet for coupling to the upper leg segment 114, etc. Alternatively, the lower leg segment 132 may instead be detachably couplable to the attachment fixture 106, which thereby rotationally fixes the upper leg segment 114 and the leg hub 112.

The hip actuator 108 and the ab/ad actuator 126 may together couple the upper leg segment 114 to the attachment fixture 106. The hip actuator 108 is positioned to rotationally align the upper leg segment 114 with the attachment fixture 106 relative to the hip axis A1, and the ab/ad actuator 126 is positioned to tilt the leg segment relative to the main body 104 into the attachment fixture 106. To couple the upper leg segment 114 to the attachment fixture 106, the hip actuator 108 may first rotate the upper leg segment 114 to be aligned with the attachment fixture 106. The upper leg segment 114 will thereby extend at least partially upward from the hip axis A1. Then the ab/ad actuator 126 may tilt the upper leg segment 114 into the attachment fixture 106 (such that the hip axis A1 tilts upward relative to the main body 104), achieving the coupling. To decouple the upper leg segment 114 from the attachment fixture 106, the ab/ad actuator 126 first tilts the upper leg segment 114 away from the attachment fixture 106 and the main body 104. The hip actuator 108 can now rotate the upper leg segment 114 freely without contacting the attachment fixture 106.

The robot 100 is switchable between the wheel mode and the leg mode. The wheel mode occurs when the upper leg segments 114 are coupled to the respective attachment fixtures 106, and the leg mode occurs when the upper leg segments 114 are decoupled from the attachment fixtures 106.

In the wheel mode, the leg segments 114, 132 are retracted upward, permitting the robot 100 to roll on the wheel hubs 110. When the upper leg segment 114 is coupled to the attachment fixture 106 (i.e., in the wheel mode), the leg hub 112 is rotationally fixed relative to the main body 104, and the wheel hub 110 is rotatably drivable by the hip actuator 108 independently of the leg hub 112. As described below, the wheel hub 110 is able to slip past the leg hub 112 when the leg hub 112 is held rotationally fixed.

In the leg mode, the robot 100 walks with the leg assemblies 116, which hold the main body 104 sufficiently high that the wheel hubs 110 do not contact the ground. When the leg segment is decoupled from the attachment fixture 106 (i.e., in the leg mode), the leg hub 112 is rotatably drivable by the hip actuator 108 together with the wheel hub 110. As described below, the leg hub 112 is held to the wheel hub 110 as the wheel hub 110 is driven by the hip actuator 108.

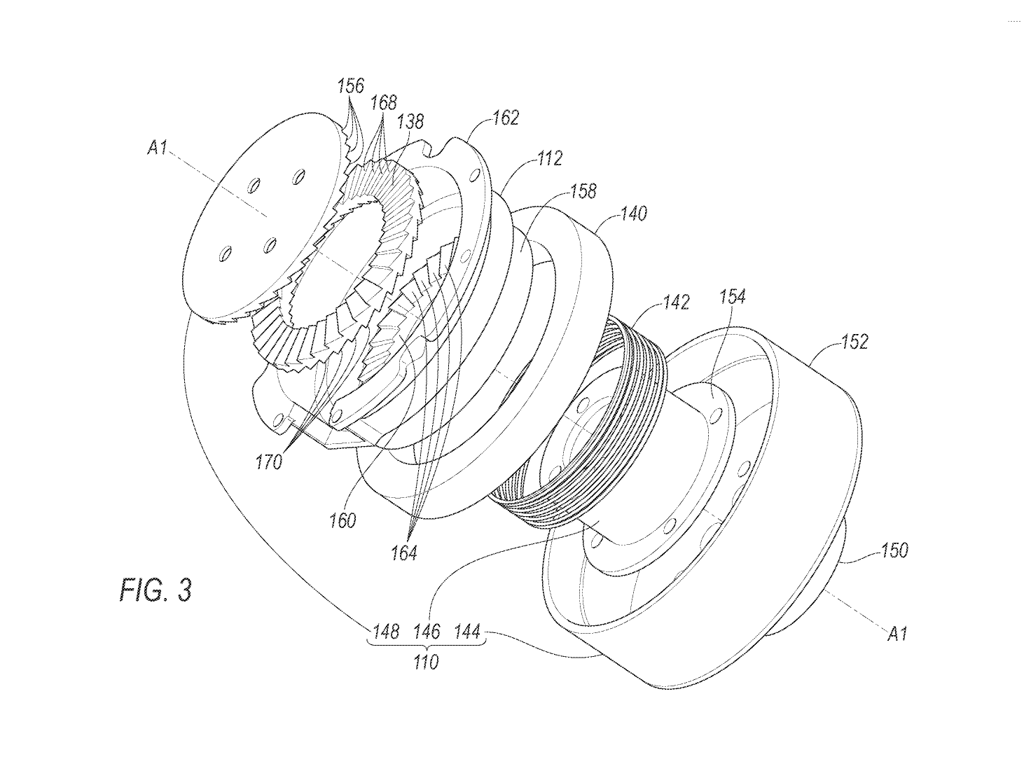

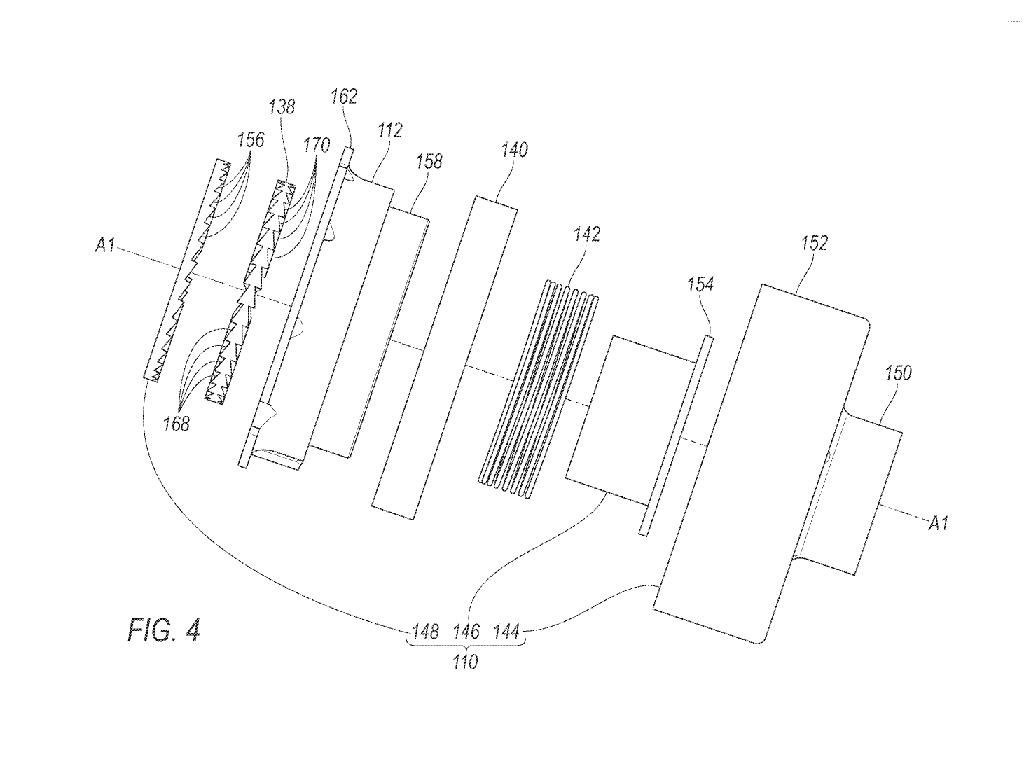

With reference to FIGS. 3–4, as a general overview, the leg assembly 116 includes the wheel hub 110, a ratchet gear 138, the leg hub 112, a bearing 140, and a spring 142. The wheel hub 110 includes a wheel rim 144, a wheel shaft 146, and a wheel plate 148, all fixedly attached together (e.g., bolted together). The ratchet gear 138, the leg hub 112, the bearing 140, and the spring 142 are held together axially between the wheel plate 148 and the wheel rim 144 along the hip axis A1.

The wheel rim 144 has a generally toroidal shape centered on the hip axis A1. The wheel rim 144 may include one axial end that is closed and one axial end that is open. The closed axial end may include a central projection 150 extending axially toward the hip actuator 108 and fixedly attached to the hip actuator 108 (seen in FIG. 2). The wheel rim 144 includes a rolling surface 152 having a cylindrical shape. The rolling surface 152 is a radially outer surface relative to the hip axis A1. The wheel rim 144 is sized to contact a ground surface below the main body 104 when the leg segment 114, 132 is coupled to the attachment fixture 106 (as seen in FIGS. 1–2). When the robot 100 is in the wheel mode, the rolling surface 152 of the wheel rim 144 (or a tire on the rolling surface 152) contacts the ground surface, and the wheel rims 144 roll to move the robot 100 around.

The wheel shaft 146 connects the wheel plate 148 and the wheel rim 144. The wheel shaft 146 may have a generally cylindrical shape centered on the hip axis A1. The wheel shaft 146 may extend axially from the wheel rim 144 to the wheel plate 148. The wheel shaft 146 may be positioned at least partially concentrically inside the wheel rim 144. The wheel shaft 146 may extend axially from the closed axial end of the wheel rim 144 through the open axial end of the wheel rim 144. The wheel shaft 146 may have a smaller diameter than the wheel rim 144 and than the wheel plate 148. The wheel shaft 146 may have a shaft lip 154 extending radially outward on the end contacting the closed axial end of the wheel rim 144.

The wheel plate 148 is fixed relative to the wheel rim 144 and wheel shaft 146. The wheel plate 148 may have a circular disc shape centered on the hip axis A1. The wheel plate 148 may be positioned concentrically in the leg hub 112. The wheel plate 148 includes a plurality of wheel-hub teeth 156 facing toward the hip actuator 108 (described in more detail below).

The leg hub 112 has a generally toroidal shape centered on the hip axis A1. The leg hub 112 may include a hollow cylindrical portion 158, a first lip 160 extending radially inward at an axial end of the cylindrical portion 158 closer to the hip actuator 108, and a second lip 162 extending radially outward at an axial end farther from the hip actuator 108. The axial end farther from the hip actuator 108 may be open. The first lip 160 may define a bore through which the wheel shaft 146 passes. The bore may have a greater diameter than the wheel shaft 146, giving clearance for the wheel shaft 146 to freely move axially and rotationally relative to the leg hub 112. The first lip 160 includes a plurality of leg-hub teeth 164 facing away from the hip actuator 108 (described in more detail below).

The bearing 140 connects the leg hub 112 and the wheel rim 144. The bearing 140 permits the leg hub 112 and wheel rim 144 to rotate relative to one another with low friction while keeping the leg hub 112 concentrically positioned with respect to the wheel rim 144. The bearing 140 may be any suitable type of rotary bearing, for example, a rolling-element bearing such as a ball bearing or a roller bearing. The bearing 140 may be positioned concentrically in the wheel rim 144, and a radially outer surface of the bearing 140 may contact a radially inner surface of the wheel rim 144. The leg hub 112 may be positioned concentrically in the bearing 140, and a radially outer surface of the leg hub 112 may contact a radially inner surface of the bearing 140.

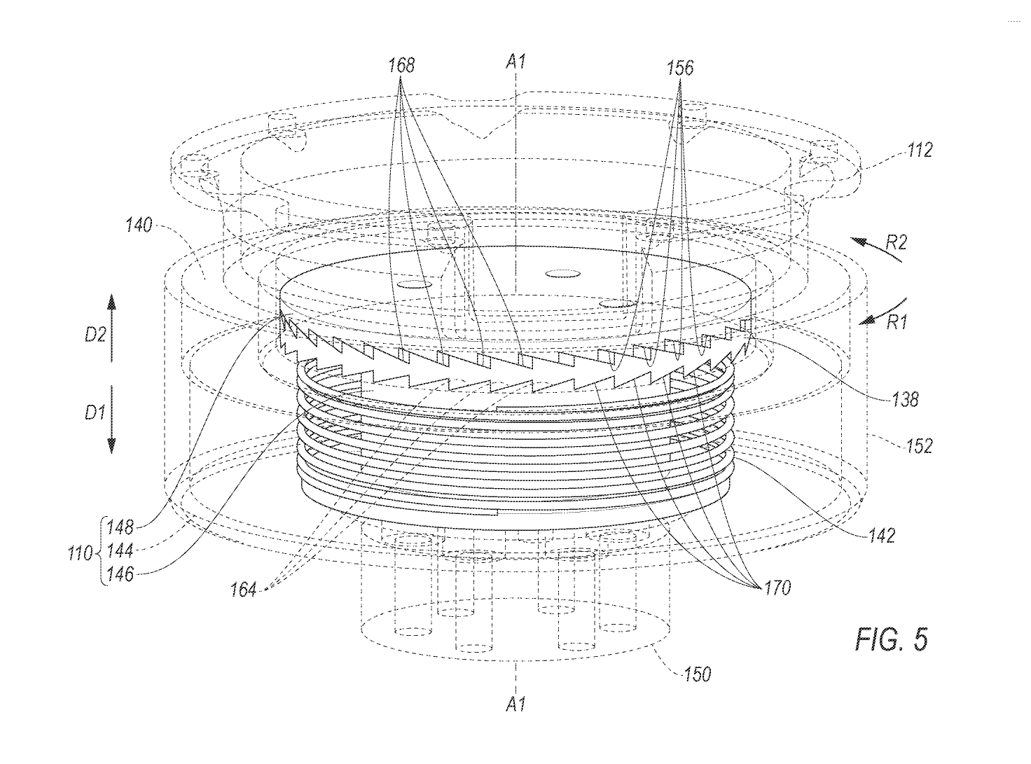

With reference to FIG. 5, the ratchet gear 138 may have a circular ring shape centered on the hip axis A1. The ratchet gear 138 is positioned axially between the wheel hub 110 and the leg hub 112 along the hip axis A1. For example, the ratchet gear 138 may be positioned axially between the wheel plate 148 of the wheel hub 110 and the first lip 160 of the leg hub 112 along the hip axis A1, with the first lip 160 closer to the hip actuator 108 than the ratchet gear 138 and the wheel plate 148 farther from the hip actuator 108 than the ratchet gear 138. The ratchet gear 138 may have an outer diameter approximately the same as the outer diameter of the wheel plate 148.

The ratchet gear 138 engages the wheel hub 110 to the leg hub 112. For example, the ratchet gear 138 includes first gear teeth 168 shaped to mate with respective ones of the wheel-hub teeth 156, and the ratchet gear 138 may include second gear teeth 170 shaped to mate with respective ones of the leg-hub teeth 164. The first gear teeth 168 may extend in a first axial direction D1 relative to the hip axis A1 (e.g., toward the hip actuator 108), and the wheel-hub teeth 156 may extend in a second axial direction D2 relative to hip axis A1 opposite the first axial direction D1 (e.g., away from the hip actuator 108) to meet the first gear teeth 168. The second gear teeth 170 may extend in the second axial direction D2 relative to the hip axis A1, and the leg-hub teeth 164 may extend in the first axial direction D1 relative to hip axis A1 to meet the second gear teeth 170. Having the gear teeth 168, 170 extend axially takes advantage of axial motion permitted by the spring 142 (described below).

The ratchet gear 138 is shaped to permit rotation of the wheel hub 110 with respect to the leg hub 112 in at least a first direction of rotation R1 about the hip axis A1 (e.g., clockwise as viewed looking along the hip axis A1 toward the hip actuator 108). For example, the first gear teeth 168 may be shaped in a sawtooth pattern, which permits rotational motion in the first direction of rotation R1 and blocks rotational motion in the second direction of rotation R2. The sawtooth pattern follows a circular path centered on the hip axis A1 and extends in the first axial direction D1 from the ratchet gear 138. The wheel-hub teeth 156 may be shaped to engage the first gear teeth 168; for example, the wheel-hub teeth 156 may have a matching sawtooth pattern. The first gear teeth 168 may define the first direction of rotation R1. For example, each of the first gear teeth 168 may include a steep side and a sloped side facing in opposite circumferential directions around the hip axis A1. The sloped side of each first gear tooth 168 is angled to permit a sloped side of a corresponding wheel-hub tooth 156 to slide past the first gear tooth 168 when the wheel hub 110 rotates in the first direction of rotation R1. The steep side of each first gear tooth 168 is angled to block a steep side of a corresponding wheel-hub tooth 156 from sliding past the first gear tooth 168 when the wheel hub 110 rotates in the second direction of rotation R2. For example, the steep sides may be parallel to the hip axis A1.

The ratchet gear 138 may be shaped to permit rotation of the wheel hub 110 with respect to the leg hub 112 in at least a second direction of rotation R2 about the hip axis A1 opposite the first direction of rotation R1 (e.g., counterclockwise as viewed looking along the hip axis A1 toward the hip actuator 108). For example, the second gear teeth 170 may be shaped in a sawtooth pattern, which permits rotational motion in the second direction of rotation R2 and blocks rotational motion in the first direction of rotation R1. The sawtooth pattern follows a circular path centered on the hip axis A1 and extends in the second axial direction D2 from the ratchet gear 138. The leg-hub teeth 164 may be shaped to engage the second gear teeth 170; for example, the leg-hub teeth 164 may have a matching sawtooth pattern. The second gear teeth 170 may define the second direction of rotation R2. For example, each of the second gear teeth 170 may include a steep side and a sloped side facing in opposite circumferential directions around the hip axis A1. The sloped side of the second gear tooth 170 is angled to permit a sloped side of a corresponding leg-hub tooth 164 to slide past the second gear tooth 170 when the wheel hub 110 and ratchet gear 138 rotate in the second direction of rotation R2. The steep side of the second gear tooth 170 is angled to block a steep side of a corresponding leg-hub tooth 164 from sliding past the second gear tooth 170 when the wheel hub 110 and ratchet gear 138 rotate in the first direction of rotation R1. For example, the steep sides may be parallel to the hip axis A1.

The spring 142 is positioned to bias the wheel hub 110 into engagement with the leg hub 112 via the ratchet gear 138. For example, the spring 142 may be positioned axially between the leg hub 112 and the wheel rim 144. The spring 142 may be in compression, thereby exerting an axial force along the hip axis A1 pushing the leg hub 112 away from the wheel rim 144 and toward the wheel plate 148. The spring 142 thus biases the leg hub 112 toward the ratchet gear 138 and toward the wheel plate 148. The spring 142 biases the first gear teeth 168 into engagement with the wheel-hub teeth 156 and biases the second gear teeth 170 into engagement with the leg-hub teeth 164. The spring 142 may be a coil spring centered on the hip axis A1. The spring 142 may be positioned concentrically around the wheel shaft 146 and concentrically within the wheel rim 144. One end of the spring 142 may contact the shaft lip 154 of the wheel shaft 146, thereby pressing against the wheel rim 144. The other end of the spring 142 may contact the leg hub 112 and press against the leg hub 112.

The leg hub 112 is rotatably drivable by the hip actuator 108 together with the wheel hub 110 when the leg segment 114, 132 is decoupled from the attachment fixture 106 (i.e., when the robot 100 is in the leg mode). The spring 142 presses the leg hub 112 into the ratchet gear 138 and the ratchet gear 138 into the wheel plate 148. When the hip actuator 108 rotates the wheel hub 110 in the first direction of rotation R1, the sloped sides of the wheel-hub teeth 156 press against the sloped sides of the first gear teeth 168, rotating the ratchet gear 138 together with the wheel hub 110. The force exerted by the spring 142 prevents the wheel-hub teeth 156 from sliding past the first gear teeth 168. The steep sides of the second gear teeth 170 press against the steep sides of the leg-hub teeth 164, rotating the leg hub 112 together with the ratchet gear 138 and the wheel hub 110.

When the hip actuator 108 rotates the wheel hub 110 in the second direction of rotation R2, the steep sides of the wheel-hub teeth 156 press against the steep sides of the first gear teeth 168, rotating the ratchet gear 138 together with the wheel hub 110. The sloped sides of the second gear teeth 170 press against the sloped sides of the leg-hub teeth 164, rotating the leg hub 112 together with the ratchet gear 138 and the wheel hub 110. The force exerted by the spring 142 prevents the second gear teeth 170 from sliding past the leg-hub teeth 164. Thus, when the robot 100 is in the leg mode, the hip actuator 108 rotates the wheel hub 110 and the leg hub 112 together, thereby moving the upper leg segment 114 so that the robot 100 can walk (combined with motions driven by the ad/ad actuator 126 and the knee actuator 130).

The leg hub 112 is rotationally fixed relative to the main body 104 and the wheel hub 110 is rotatably drivable by the hip actuator 108 independently of the leg hub 112 when the leg segment 114, 132 is coupled to the attachment fixture 106 (i.e., when the robot 100 is in the wheel mode). When the hip actuator 108 rotates the wheel hub 110 in the first direction of rotation R1, the leg hub 112 resists the rotation. The steep sides of the leg-hub teeth 164 press against the steep sides of the second gear teeth 170, preventing the ratchet gear 138 from rotating with the wheel hub 110. The sloped sides of the wheel-hub teeth 156 press against the sloped sides of the first gear teeth 168, causing the ratchet gear 138 and leg hub 112 to move axially, overcoming the force of the spring 142, thereby permitting the wheel-hub teeth 156 to slide by the first gear teeth 168. The wheel hub 110 thus rotates in the first direction of rotation R1 while the leg hub 112 is rotationally fixed.

When the hip actuator 108 rotates the wheel hub 110 in the second direction of rotation R2, the leg hub 112 resists the rotation. The steep sides of the wheel-hub teeth 156 press against the steep sides of the first gear teeth 168, rotating the ratchet gear 138 together with the wheel hub 110. The sloped sides of the second gear teeth 170 press against the sloped sides of the leg-hub teeth 164, causing the leg hub 112 to move axially, overcoming the force of the spring 142, thereby permitting the second gear teeth 170 to slide by the leg-hub teeth 164. The wheel hub 110 thus rotates in the second direction of rotation R2 while the leg hub 112 is rotationally fixed. Thus, when the robot 100 is in the wheel mode, the hip actuators 108 rotate the wheel hubs 110 to drive around the robot 100, while the leg hubs 112 are rotationally stationary and the leg segments 114, 132 are kept out of the way of the driving.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described. Operations, systems, and methods described herein should always be implemented and/or performed in accordance with an applicable owner’s/user’s manual and/or safety guidelines.

What is claimed is:

1. A robotic apparatus comprising:
a main body;
an attachment fixture fixed relative to the main body;
a hip actuator coupled to the main body and defining a hip axis of rotation;
a wheel hub coupled to the hip actuator, centered on the hip axis, and rotatably drivable by the hip actuator about the hip axis;
a leg hub coupled to the wheel hub and centered on the hip axis; and
a leg segment elongated radially outward from the leg hub relative to the hip axis, the leg segment fixed relative to the leg hub;
the leg segment being detachably couplable to the attachment fixture;
the leg hub being rotatably drivable by the hip actuator together with the wheel hub when the leg segment is decoupled from the attachment fixture; and
the leg hub being rotationally fixed relative to the main body and the wheel hub being rotatably drivable by the hip actuator independently of the leg hub when the leg segment is coupled to the attachment fixture.

2. The robotic apparatus of claim 1, further comprising a ratchet gear positioned axially between the wheel hub and the leg hub along the hip axis, the ratchet gear engaging the wheel hub to the leg hub, the ratchet gear shaped to permit rotation of the wheel hub with respect to the leg hub in at least a first direction of rotation about the hip axis.

3. The robotic apparatus of claim 2, further comprising a spring positioned to bias the wheel hub into engagement with the leg hub via the ratchet gear.

4. The robotic apparatus of claim 3, wherein the spring is a coil spring centered on the hip axis.

5. The robotic apparatus of claim 2, wherein the ratchet gear is shaped to permit rotation of the wheel hub with respect to the leg hub in a second direction of rotation about the hip axis opposite the first direction of rotation.

6. The robotic apparatus of claim 2, wherein the ratchet gear includes a plurality of gear teeth shaped in a sawtooth pattern, the gear teeth extending in an axial direction relative to the hip axis.

7. The robotic apparatus of claim 6, wherein the leg hub includes a plurality of leg-hub teeth shaped to engage the gear teeth.

8. The robotic apparatus of claim 6, wherein
the gear teeth are first gear teeth;
the first gear teeth extend in a first axial direction relative to the hip axis;
the first gear teeth define the first direction of rotation;
the ratchet gear includes a plurality of second gear teeth shaped in a sawtooth pattern;
the second gear teeth extend in a second axial direction relative to the hip axis opposite the first axial direction; and
the second gear teeth define a second direction of rotation about the hip axis opposite the first direction of rotation.

9. The robotic apparatus of claim 6, wherein the wheel hub includes a plurality of wheel-hub teeth shaped to engage the gear teeth.

10. The robotic apparatus of claim 9, wherein the wheel hub includes a wheel rim including a rolling surface, the wheel hub includes a wheel plate fixed relative to the wheel rim, the wheel plate includes the wheel-hub teeth, and the ratchet gear is positioned axially between the wheel plate and the leg hub relative to the hip axis.

11. The robotic apparatus of claim 10, further comprising a spring positioned to bias the leg hub toward the wheel plate.

12. The robotic apparatus of claim 11, wherein the spring is positioned axially between the leg hub and the wheel rim.

13. The robotic apparatus of claim 12, wherein the wheel hub includes a wheel shaft connecting the wheel plate and the wheel rim, and the spring is positioned concentrically around the wheel shaft.

14. The robotic apparatus of claim 1, further comprising an ab/ad actuator coupling the hip actuator to the main body, the ab/ad actuator defining an ab/ad axis of rotation nonparallel to the hip axis, the ab/ad actuator positioned to rotate the hip actuator about the ab/ad axis.

15. The robotic apparatus of claim 14, wherein the ab/ad actuator is positioned to tilt the leg segment relative to the main body into the attachment fixture.

16. The robotic apparatus of claim 1, wherein the wheel hub includes a wheel rim sized to contact a ground surface below the main body when the leg segment is coupled to the attachment fixture.

17. The robotic apparatus of claim 1, wherein the leg segment is an upper leg segment, the robotic apparatus further comprising a lower leg segment and a knee actuator, the upper leg segment is elongated from the leg hub to a knee joint, the lower leg segment is rotatably coupled to the upper leg segment at the knee joint, and the knee actuator is positioned to rotatably drive the lower leg segment relative to the upper leg segment.

18. The robotic apparatus of claim 17, wherein the knee actuator is positioned concentrically in the leg hub.

19. The robotic apparatus of claim 1, further comprising:
a second attachment fixture fixed relative to the main body;
a second hip actuator coupled to the main body and defining a second hip axis of rotation;
a second wheel hub coupled to the second hip actuator, centered on the second hip axis, and rotatably drivable by the second hip actuator about the second hip axis;
a second leg hub coupled to the second wheel hub and centered on the second hip axis; and
a second leg segment elongated radially outward from the second leg hub relative to the second hip axis, the second leg segment fixed relative to the second leg hub;
the second leg segment being detachably couplable to the second attachment fixture;
the second leg hub being rotatably drivable by the second hip actuator together with the second wheel hub when the second leg segment is decoupled from the second attachment fixture;
the second leg hub being rotationally fixed relative to the main body and the second wheel hub being rotatably drivable by the second hip actuator independently of the second leg hub when the second leg segment is coupled to the second attachment fixture; and
the second attachment fixture, the second hip actuator, the second wheel hub, the second leg hub, and the second leg segment being symmetrical across the main body with the attachment fixture, the hip actuator, the wheel hub, the leg hub, and the leg segment, respectively.

20. The robotic apparatus of claim 1, further comprising an actuatable arm coupled to the main body.
